(19) United States
(12) Patent Application Publication
(10) Pub. No.: US 2014/0358952 A1
(43) Pub. Date: Dec. 4, 2014

(54) GENERATION AND MAINTENANCE OF SYNTHETIC EVENTS FROM SYNTHETIC CONTEXT OBJECTS

(71) Applicant: International Business Machines Corporation, Armonk, NY (US)

(72) Inventors: Samuel Scott Adams, Rutherfordton, NC (US); Robert R. Friedlander, Southbury, CT (US); James R. Kraemer, Santa Fe, NM (US); Jeb R. Linton, Manassas, VA (US)

(21) Appl. No.: 13/906,658

(22) Filed: May 31, 2013

(51) Int. Cl. G06F 17/30

(52) U.S. Cl. CPC G06F 17/30386
USPC 707/758

(57) ABSTRACT

A method, computer program product and system for generating and maintaining synthetic context events. The steps include searching a data structure of synthetic context-based objects and associated data for a pattern of context exhibited at a first specified frequency within a first specified time period; combining the synthetic context-based objects and associated data exhibiting the pattern of context exhibited at the first specified frequency within the first specified time period into a synthetic context event; and optimizing and maintaining the synthetic context event by searching the data structure for additional synthetic context-based objects and associated data exhibiting a same pattern of context at a second specified time period different than the first specified time period and adding the additional synthetic context-based objects and associated data to the synthetic context event.

### BACKGROUND

The present invention relates to synthetic events, and more specifically to the generation and maintenance of synthetic events from synthetic context objects.

### SUMMARY

According to one embodiment of the present invention, a method of generating and maintaining synthetic context events. The method comprises the steps of: a computer searching a data structure of synthetic context-based objects and associated data for a pattern of context exhibited at a first specified frequency within a first specified time period; the computer combining the synthetic context-based objects and associated data exhibiting the pattern of context exhibited at the first specified frequency within the first specified time period into a synthetic context event; and the computer optimizing and maintaining the synthetic context event by searching the data structure for additional synthetic context-based objects and associated data exhibiting a same pattern of context at a second specified time period different than the first specified time period and adding the additional synthetic context-based objects and associated data to the synthetic context event.

According to another embodiment of the present invention, a computer program product for generating and maintaining synthetic context events. The computer program product comprises: one or more computer-readable, tangible storage devices; program instructions, stored on at least one of the one or more storage devices, to search a data structure of synthetic context-based objects and associated data for a pattern of context exhibited at a first specified frequency within a first specified time period; program instructions, stored on at least one of the one or more storage devices, to combine the synthetic context-based objects and associated data exhibiting the pattern of context exhibited at the first specified frequency within the first specified time period into a synthetic context event; and program instructions, stored on at least one of the one or more storage devices, to optimize and maintain the synthetic context event by searching the data structure for additional synthetic context-based objects and associated data exhibiting a same pattern of context at a second specified time period different than the first specified time period and adding the additional synthetic context-based objects and associated data to the synthetic context event.

According to another embodiment of the present invention, a system for generating and maintaining synthetic context events. The system comprises: one or more processors, one or more computer-readable memories and one or more computer-readable, tangible storage devices; program instructions, stored on at least one of the one or more storage devices for execution by at least one of the one or more processors via at least one of the one or more memories, to search a data structure of synthetic context-based objects and associated data for a pattern of context exhibited at a first specified frequency within a first specified time period; program instructions, stored on at least one of the one or more storage devices for execution by at least one of the one or more processors via at least one of the one or more memories, to combine the synthetic context-based objects and associated data exhibiting the pattern of context exhibited at the first specified frequency within the first specified time period into a synthetic context event; and program instructions, stored on at least one of the one or more storage devices for execution by at least one of the one or more processors via at least one of the one or more memories, to optimize and maintain the synthetic context event by searching the data structure for additional synthetic context-based objects and associated data exhibiting a same pattern of context at a second specified time period different than the first specified time period and adding the additional synthetic context-based objects and associated data to the synthetic context event.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a process for generating one or more synthetic context-based objects.

FIG. 3 depicts an exemplary case in which synthetic context-based objects are defined for the non-contextual data object datum “Rock”.

FIG. 4 illustrates an exemplary case in which synthetic context-based objects are defined for the non-contextual data object data “104-106”.

FIG. 5 depicts an exemplary case in which synthetic context-based objects are defined for the non-contextual data object datum “Statin”.

FIG. 6 shows a method for the generation and maintenance of synthetic events from synthetic context-based objects.

FIG. 7 shows a method of optimizing and maintaining the synthetic context event.

FIG. 8 shows illustrates internal and external components of a client computer and a server computer in which illustrative embodiments may be implemented.

### DETAILED DESCRIPTION

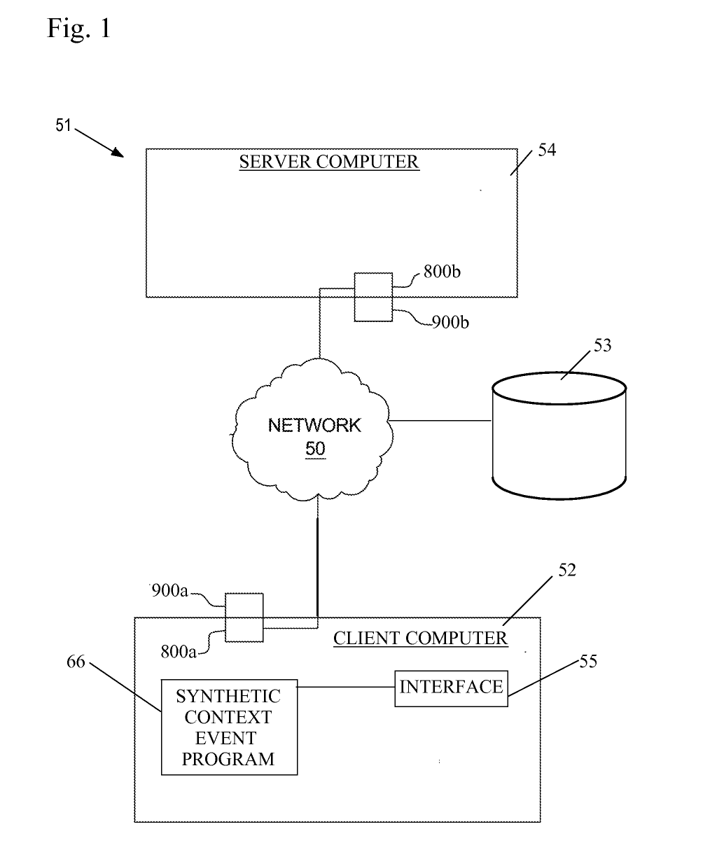

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

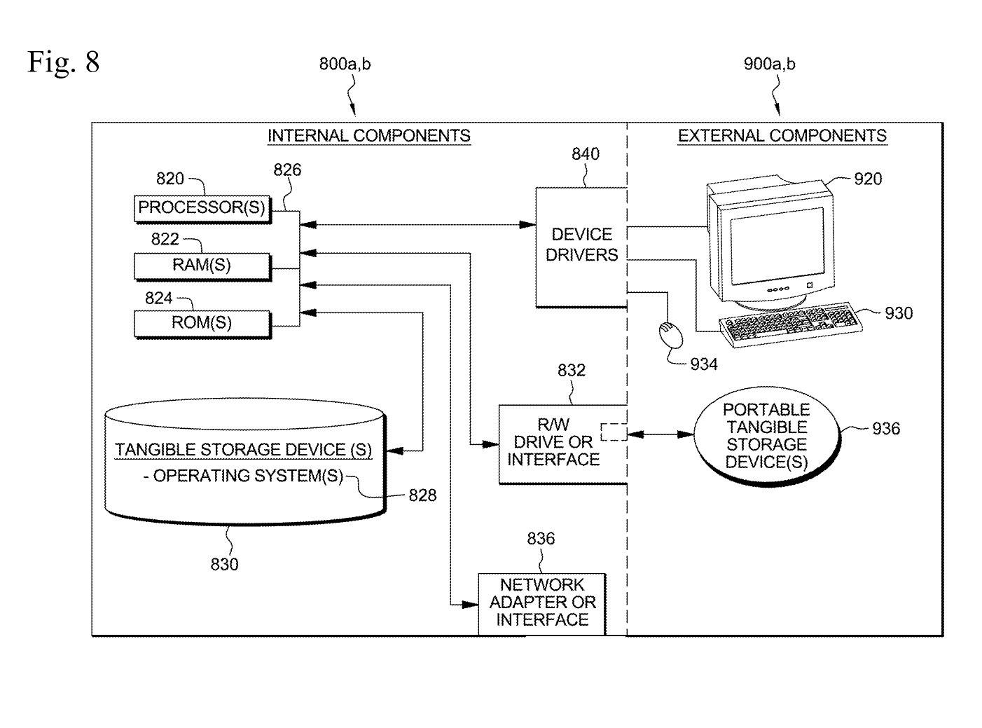

In the depicted example, client computer 52, repository 53, and server computer 54 connect to network 50. In other exemplary embodiments, network data processing system 51 may include additional client computers, storage devices, server computers, and other devices not shown. Client computer 52 includes a set of internal components 800a and a set of external components 900a, further illustrated in FIG. 8. Client computer 52 may be, for example, a mobile device, a cell phone, a personal digital assistant, a netbook, a laptop computer, a tablet computer, a desktop computer, or any other type of computing device.

Client computer 52 may contain an interface 55. Through the interface 55, specified time periods, frequency of context patterns, synthetic context-based objects, and synthetic context events may be viewed by the user. The interface 55 may accept commands and data entry from a user, for example specified time periods in which to search for a repeating pattern of context or frequency of the context patterns. The interface 55 can be, for example, a command line interface, a graphical user interface (GUI), or a web user interface (WUI) through which a user can access a synthetic context event program 66 on the client computer 52.

In the depicted example, server computer 54 provides information, such as boot files, operating system images, and applications to client computer 52. Server computer 54 includes a set of internal components 800b and a set of external components 900b illustrated in FIG. 8 and may also include the components shown in FIG. 8.

Program code, synthetic context-based objects, synthetic context events, and programs such as a synthetic context event program 66 may be stored on at least one of one or more computer-readable tangible storage devices 830 shown in FIG. 8, on at least one of one or more portable computer-readable tangible storage devices 936 as shown in FIG. 8, on repository 53 connected to network 50, or downloaded to a data processing system or other device for use.

For example, program code, synthetic context-based objects, synthetic context events and programs such as a synthetic context event program 66 may be stored on at least one of one or more tangible storage devices 830 on server computer 54 and downloaded to client computer 52 over network 50 for use on client computer 52. Alternatively, server computer 54 can be a web server, and the program code, synthetic context-based objects, synthetic context events, and programs such as a synthetic context event program 66 may be stored on at least one of the one or more tangible storage devices 830 on server computer 54 and accessed on client computer 52. Synthetic context event program 66 can be accessed on client computer 52 through interface 55. In other exemplary embodiments, the program code, synthetic context-based objects, synthetic context events, and synthetic context event program 66 may be stored on at least one of one or more computer-readable tangible storage devices 830 on client computer 52 or distributed between two or more servers.

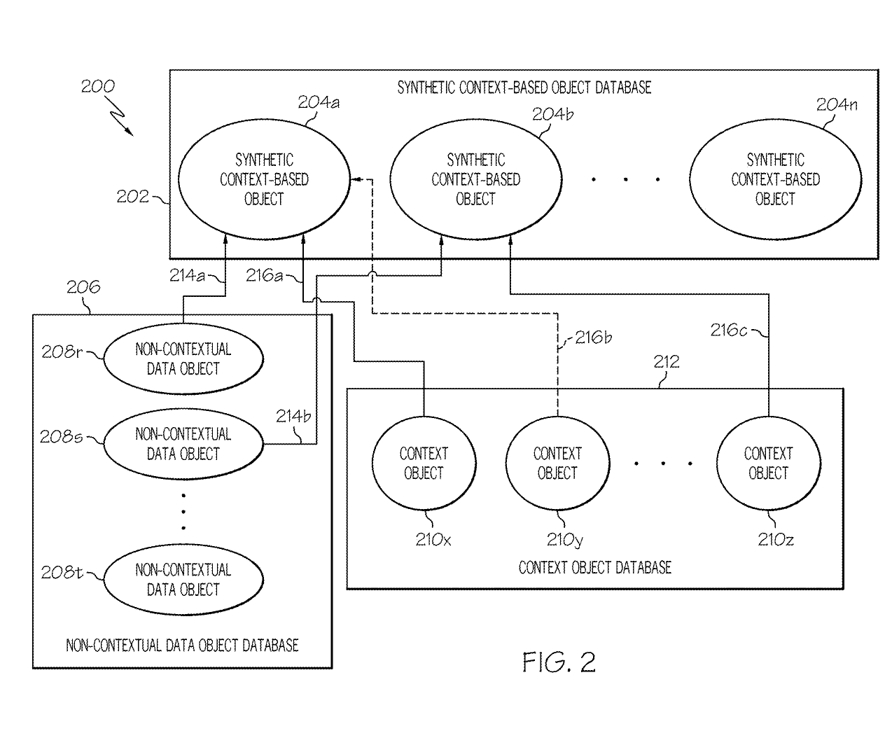

With reference now to FIG. 2, a process for generating one or more synthetic context based objects in a system 200 is presented. Note that system 200 is a processing and storage logic found in computer and/or data storage system 51 shown in FIG. 1, which process, support, and/or contain the databases, pointers, and objects depicted in FIG. 2.

Within system 200 is a synthetic context-based object database 202, which contains multiple synthetic context-based objects 204a-204n (thus indicating an “n” quantity of objects, where “n” is an integer). Each of the synthetic context-based objects 204a-204n is defined by at least one non-contextual data object and at least one context object. That is, at least one non-contextual data object is associated with at least one context object to define one or more of the synthetic context-based objects 204a-204n. The non-contextual data object ambiguously relates to multiple subject-matters, and the context object provides a context that identifies a specific subject-matter, from the multiple subject-matters, of the non-contextual data object.

Note that the non-contextual data objects contain data that has no meaning in and of itself. That is, the data in the context objects are not merely attributes or descriptors of the data/objects described by the non-contextual data objects. Rather, the context objects provide additional information about the non-contextual data objects in order to give these non-contextual data objects meaning. Thus, the context objects do not merely describe something, but rather they define what something is. Without the context objects, the non-contextual data objects contain data that is meaningless; with the context objects, the non-contextual data objects become meaningful.

For example, assume that a non-contextual data object database 206 includes multiple non-contextual data objects 208r-208t (thus indicating a “t” quantity of objects, where “t” is an integer). However, data within each of these non-contextual data objects 208r-208t by itself is ambiguous, since it has no context. That is, the data within each of the non-contextual data objects 208r-208t is data that, standing alone, has no meaning, and thus is ambiguous with regards to its subject-matter. In order to give the data within each of the non-contextual data objects 208r-208t meaning, they are given context, which is provided by data contained within one or more of the context objects 210x-210z (thus indicating a “z” quantity of objects, where “z” is an integer) stored within a context object database 212. For example, if a pointer 214a points the non-contextual data object 208r to the synthetic context-based object 204a, while a pointer 216a points the context object 210x to the synthetic context-based object 204a, thus associating the non-contextual data object 208r and the context object 210x with the synthetic context-based object 204a (e.g., storing or otherwise associating the data within the non-contextual data object 208r and the context object 210x in the synthetic context-based object 204a), the data within the non-contextual data object 208r now has been given unambiguous meaning by the data within the context object 210x. This contextual meaning is thus stored within (or otherwise associated with) the synthetic context-based object 204a.

Similarly, if a pointer 214b associates data within the non-contextual data object 208s with the synthetic context-based object 204b, while the pointer 216c associates data within the context object 210z with the synthetic context-based object 204b, then the data within the non-contextual data object 208s is now given meaning by the data in the context object 210z. This contextual meaning is thus stored within (or otherwise associated with) the synthetic context based object 204b.

Note that more than one context object can give meaning to a particular non-contextual data object. For example, both context object 210x and context object 210y can point to the synthetic context-based object 204a, thus providing compound context meaning to the non-contextual data object 208r shown in FIG. 2. This compound context meaning provides various layers of context to the data in the non-contextual data object 208r.

Note also that while the pointers 214a-214b and 216a-216c are logically shown pointing toward one or more of the synthetic context-based objects 204a-204n, in one embodiment the synthetic context-based objects 204a-204n actually point to the non-contextual data objects 208r-208t and the context objects 210x-210z. That is, in one embodiment the synthetic context based objects 204a-204n locate the non-contextual data objects 208r-208t and the context objects 210x-210z through the use of the pointers 214a-214b and 216a-216c.

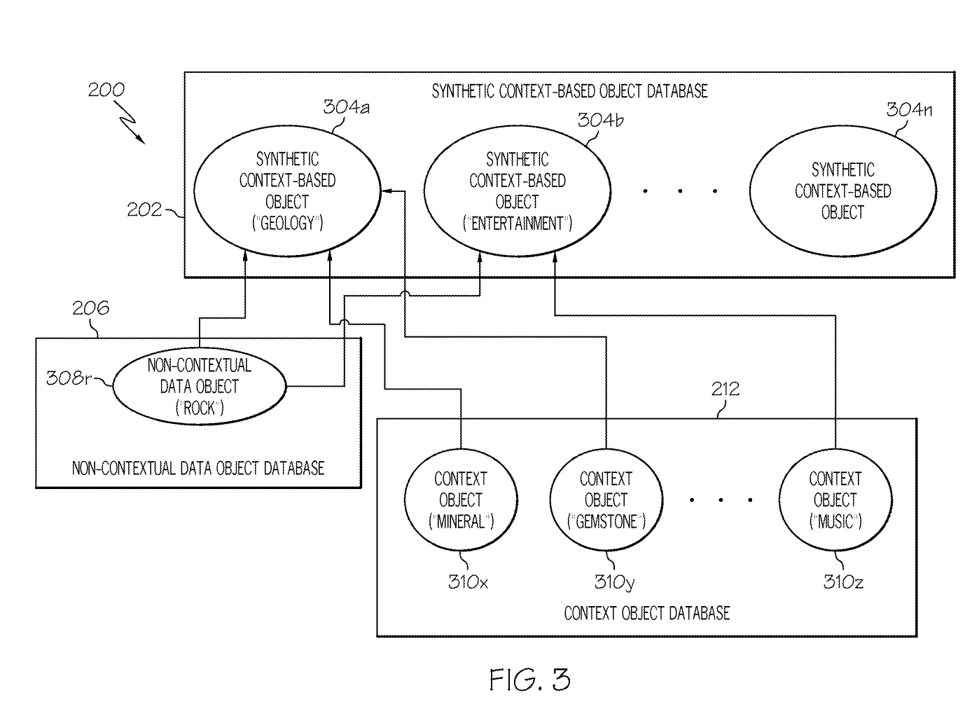

Consider now an exemplary case depicted in FIG. 3, in which synthetic context-based objects are defined for the non-contextual data object data “rock”. Standing alone, without any context, the word “rock” is meaningless, since it is ambiguous and does not provide a reference to any particular subject-matter. That is, “rock” may refer to a stone, or it may be slang for a gemstone such as a diamond, or it may refer to a genre of music, or it may refer to physical oscillation, etc. Thus, each of these references are within the context of a different subject matter (e.g., geology, entertainment, physics, etc.).

In the example shown in FIG. 3, then, data (i.e., the word “rock”) from the non-contextual data object 308r is associated with (e.g., stored in or associated by a look-up table, etc.) a synthetic context-based object 304a, which is devoted to the subject-matter “geology”. The data/word “rock” from non-contextual data object 308r is also associated with a synthetic context-based object 304b, which is devoted to the subject-matter “entertainment”. In order to give contextual meaning to the word “rock” (i.e., define the term “rock”) in the context of “geology”, context object 310x, which contains the context datum “mineral”, is associated with (e.g., stored in or associated by a look-up table, etc.) the synthetic context-based object 304a. In one embodiment, more than one context datum can be associated with a single synthetic context based object. Thus, in the example shown in FIG. 3, the context object 310y, which contains the datum “gemstone”, is also associated with the synthetic context-based object 304a.

Associated with the synthetic context-based object 304b is a context object 310z, which provides the context/datum of “music” to the term “rock” provided by the non-contextual data object 308r. Thus, the synthetic context-based object 304a defines “rock” as that which is related to the subject-matter “geology”, including minerals and/or gemstones, while synthetic context-based object 304b defines “rock” as that which is related to the subject-matter “entertainment”, including music.

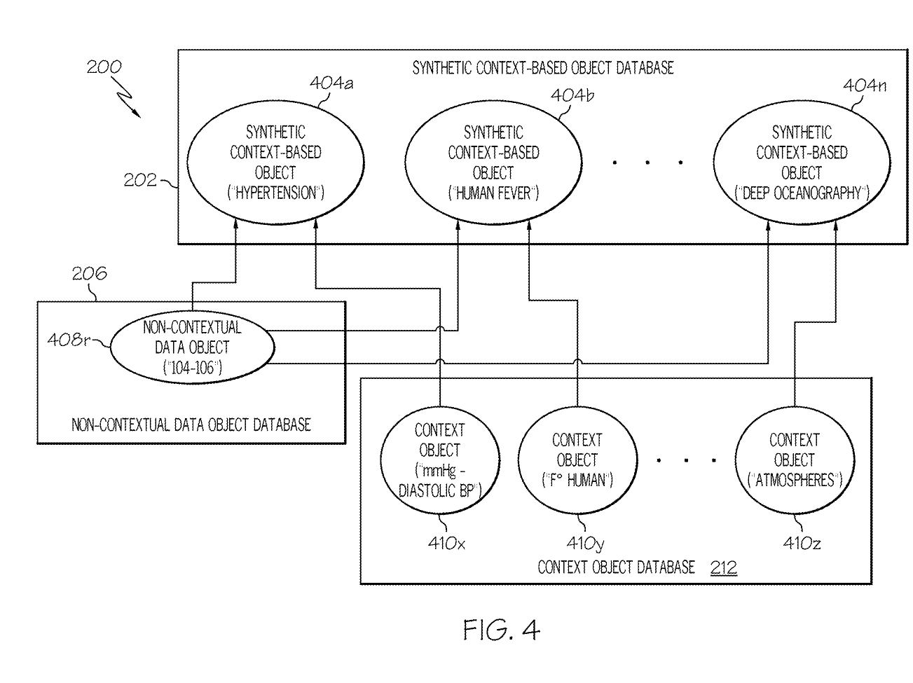

In one embodiment, the data within a non-contextual data object is even more meaningless if it is merely a combination of numbers and/or letters. For example, consider the data “104-106” contained within a non-contextual data object 408r depicted in FIG. 4. Standing alone, without any context, these numbers are meaningless, identify no particular subject-matter, and thus are completely ambiguous. That is, “104-106” may relate to subject-matter such as a medical condition, a physics value, a person's age, a quantity of currency, a person's identification number, etc. That is, the data “104-106” is so vague/meaningless that the data does not even identify the units that the term describes, much less the context of these units.

In the example shown in FIG. 4, then, data (i.e., the term/values “104-106”) from the non-contextual data object 408r is associated with (e.g., stored in or associated by a look-up table, etc.) a synthetic context-based object 404a, which is devoted to the subject-matter “hypertension”. The term/values “104-106” from non-contextual data object 408r is also associated with a synthetic context-based object 404b, which is devoted to the subject-matter “human fever” and a synthetic context-based object 404n, which is devoted to the subject-matter “deep oceanography”. In order to give contextual meaning to the term/values “104-106” (i.e., define the term/values “104-106”) in the context of “hypertension”, context object 410x, which contains the context data “millimeters of mercury” and “diastolic blood pressure” is associated with (e.g., stored in or associated by a look-up table, etc.) the synthetic context-based object 404a. Thus, multiple context data can provide not only the scale/units (millimeters of mercury) context of the values “104-106”, but the data can also provide the context data “diastolic blood pressure” needed to identify the subject-matter (hypertension) of the synthetic context-based object 404a.

Associated with the synthetic context-based object 404b is a context object 410y, which provides the context data of “degrees on the Fahrenheit scale” and “human” to the term/values “104-106” provided by the non-contextual data object 408r. Thus, the synthetic context-based object 404b now defines term/values “104-106” as that which is related to the subject matter of “human fever” Similarly, associated with the synthetic context-based object 404n is a context object 410z, which provides the context data of “atmospheres” to the term/values “104-106” provided by the non-contextual data object 408r. In this case, the generator of the synthetic context-based object database 202 determines that high numbers of atmospheres are used to define deep ocean pressures. Thus, the synthetic context-based object 404n now defines term/values “104-106” as that which is related to the subject matter of “deep oceanography”.

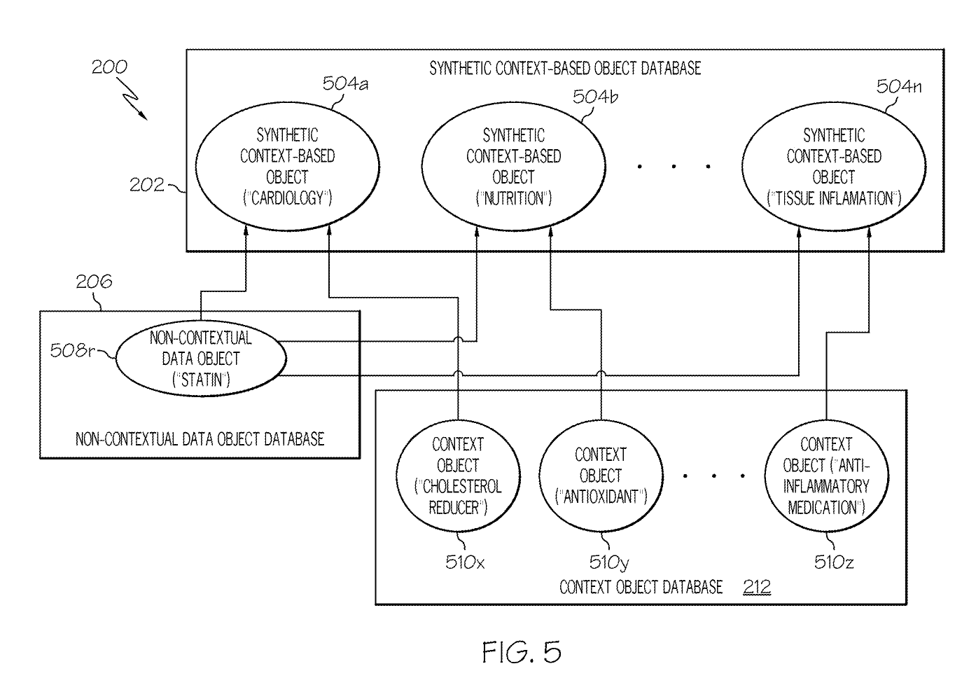

In one embodiment, the non-contextual data object may provide enough self-context to identify what the datum is, but not what it means and/or is used for. For example, consider the datum “statin” contained within the non-contextual data object 508r shown in FIG. 5. In the example shown in FIG. 5, datum (i.e., the term “statin”) from the non-contextual data object 508r is associated with (e.g., stored in or associated by a look-up table, etc.) a synthetic context-based object 504a, which is devoted to the subject-matter “cardiology”. The term “statin” from non-contextual data object 508r is also associated with a synthetic context-based object 504b, which is devoted to the subject-matter “nutrition” and a synthetic context-based object 504a, which is devoted to the subject-matter “tissue inflammation”. In order to give contextual meaning to the term “statin” (i.e., define the term “statin”) in the context of “cardiology”, context object 510x, which contains the context data “cholesterol reducer” is associated with (e.g., stored in or associated by a look-up table, etc.) the synthetic context-based object 504a. Thus, the datum “cholesterol reducer” from context object 510x provides the context to understand that “statin” is used in the context of the subject-matter “cardiology”.

Associated with the synthetic context-based object 504b is a context object 510y, which provides the context/datum of “antioxidant” to the term “statin” provided by the non-contextual data object 508r. That is, a statin has properties both as a cholesterol reducer as well as an antioxidant. Thus, a statin can be considered in the context of reducing cholesterol (i.e., as described by the subject-matter of synthetic context-based object 504a), or it may considered in the context of being an antioxidant (i.e., as related to the subject-matter of synthetic context based object 504b). Similarly, a statin can also be an anti-inflammatory medicine. Thus, associated with the synthetic context-based object 504n is the context object 510z, which provides the context data of “anti-inflammatory medication” to the term “statin” provided by the non-contextual data object 508r. This combination identifies the subject-matter of the synthetic context-based object 504n as “tissue inflammation”.

Once the synthetic context-based objects are defined, they can be linked to data stores. A data store is defined as a data repository of a set of integrated data, such as text files, video files, webpages, etc. Multiple data stores may be organized into a data structure.

That is, in one embodiment, the data structure is a database of text documents (represented by one or more of the data stores), such as journal articles, webpage articles, electronically-stored business/medical/operational notes, etc.

In one embodiment, the data structure is a database of text, audio, video, multimedia, etc. files (represented by one or more of the data stores) that are stored in a hierarchical manner, such as in a tree diagram, a lightweight directory access protocol (LDAP) folder, etc.

In one embodiment, the data structure is a relational database, which is a collection of data items organized through a set of formally described tables. A table is made up of one or more rows, known as “tuples”. Each of the tuples (represented by one or more of the data stores) share common attributes, which in the table are described by column headings. Each tuple also includes a key, which may be a primary key or a foreign key. A primary key is an identifier (e.g., a letter, number, symbol, etc.) that is stored in a first data cell of a local tuple. A foreign key is typically identical to the primary key, except that it is stored in a first data cell of a remote tuple, thus allowing the local tuple to be logically linked to the foreign tuple.

In one embodiment, the data structure is an object oriented database, which stores objects (represented by one or more of the data stores). As understood by those skilled in the art of computer software, an object contains both attributes, which are data (i.e., integers, strings, real numbers, references to another object, etc.), as well as methods, which are similar to procedures/functions, and which define the behavior of the object. Thus, the object oriented database contains both executable code and data

In one embodiment, the data structure is a spreadsheet, which is made up of rows and columns of cells (represented by one or more of the data stores). Each cell (represented by one or more of the data stores) contains numeric or text data, or a formula to calculate a value based on the content of one or more of the other cells in the spreadsheet.

In one embodiment, the data structure is a collection of universal resource locators (URLs) for identifying a webpage, in which each URL (or a collection of URLs) is represented by one or more of the data stores.

These described types of data stores are exemplary, and are not to be construed as limiting what types of data stores are found within data structure.

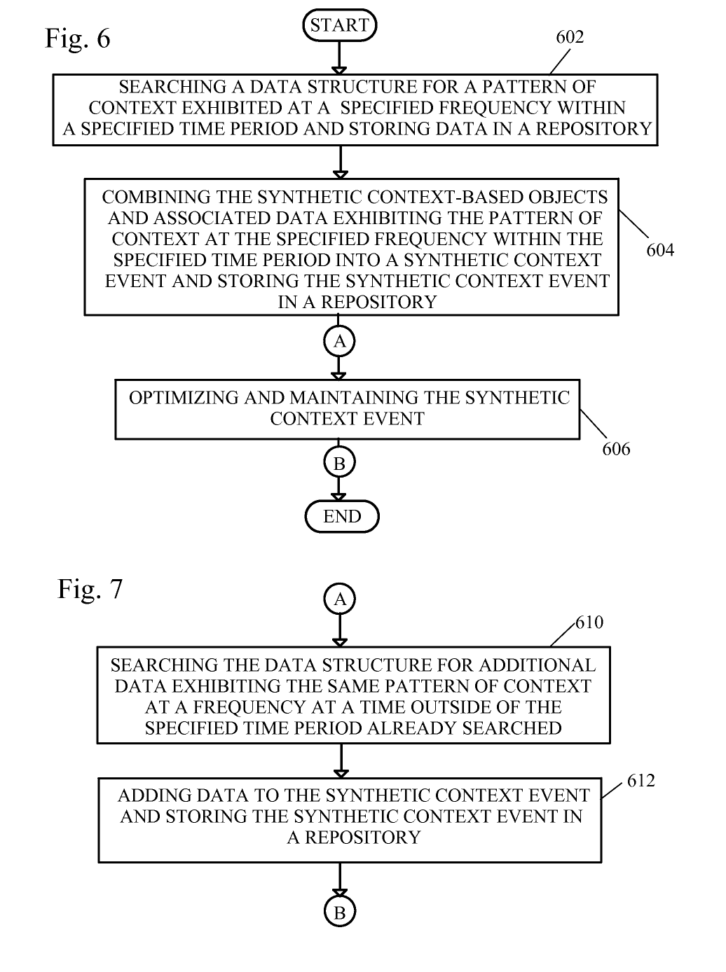

FIGS. 6-7 show flowcharts of a method for the generation and maintenance of synthetic events from synthetic context-based objects.

In a first step, a data structure is searched for data exhibiting a repeating pattern of context or pattern expressed at a set frequency within a specified time period (step 602), for example by the synthetic context event program 66. The results are preferably stored in a repository or database, for example repository 53 of FIG. 1 or synthetic context-based object database 202 of FIG. 2. The specified time period and the frequency of how often a pattern of context may need to be present or exhibit in order to satisfy the search may be set and altered by a user. The specified time period and the frequency in which the pattern of context may need to exhibit is preferably received prior to step 602.

The data, which is preferably synthetic context-based objects and any associated data, that matches the search of step 602 are combined into a synthetic context event and the synthetic context events are stored in a repository or database (step 604), for example repository 53 of FIG. 1 or synthetic context-based object database 202 of FIG. 2. A synthetic context event is at least one synthetic context-based object and associated data or information from clustering of information based on preset parameters, which in this case are the presence of a pattern of context repeating a specific number of times or occurring at a specified frequency within a specific time period.

The synthetic context events are optimized or maintained (step 606) and the method ends. Referring to FIG. 7, step 606 is shown in greater detail. The data structure is searched for additional data exhibiting the searched pattern of context at a determined frequency outside of the specified time period originally searched or at another specified time period and the results are stored in a repository or database (step 610), for example by the synthetic context event program 66. The data structure may be a database of text documents, database of text, audio, video, etc. . . . , a relational database, an object oriented database, a spreadsheet, a collection of URLs, or other data structure. The data outside of the specified time period that has the pattern at a specific frequency or number of repeats is added to the synthetic context event, for example by the synthetic context event 66, and the synthetic context event is stored in a repository or database (step 612).

It should be noted that the specified time period of step 602 is preferably different than the specified time period of step 610. Furthermore, the frequency of the pattern of context exhibited within the time period may be the same in both steps 602 and 610 or may differ. The frequency may be specified as being continuous or discontinuous within the specified time period.

FIG. 8 illustrates internal and external components of client computer 52 and server computer 54 in which illustrative embodiments may be implemented. In FIG. 8, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, a surprisal context filter program 66 are stored on one or more of the computer-readable tangible storage devices 830 for execution by one or more of the processors 820 via one or more of the RAMs 822 (which typically include cache memory). In the embodiment illustrated in FIG. 8, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A surprisal context filter program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. A synthetic context event program 66 can be downloaded to client computer 52 and server computer 54 from an external computer via a network (for example, the Internet, a local area network or other, wide area network) and network adapter or interface 836. From the network adapter or interface 836, a synthetic context event program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

A synthetic context event program 66 can be written in various programming languages including low-level, high-level, object-oriented or non object-oriented languages. Alternatively, the functions of a synthetic context event program 66 can be implemented in whole or in part by computer circuits and other hardware (not shown).

Based on the foregoing, a computer system, method, and program product have been disclosed for generating and maintaining synthetic context events. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method of generating and maintaining synthetic context events comprising the steps of:
a computer searching a data structure of synthetic context-based objects and associated data for a pattern of context exhibited at a first specified frequency within a first specified time period;
the computer combining the synthetic context-based objects and associated data exhibiting the pattern of context exhibited at the first specified frequency within the first specified time period into a synthetic context event; and
the computer optimizing and maintaining the synthetic context event by searching the data structure for additional synthetic context-based objects and associated data exhibiting a same pattern of context at a second specified time period different than the first specified time period and adding the additional synthetic context-based objects and associated data to the synthetic context event.

2. The method of claim 1, wherein the step of the computer optimizing and maintaining the synthetic context event by searching the data structure for additional synthetic context-based objects and associated data exhibiting the same pattern of context at the second specified time period further comprises searching for the same pattern of context exhibited at the first specified frequency.

3. The method of claim 1, wherein the step of the computer optimizing and maintaining the synthetic context event by searching the data structure for additional synthetic context-based objects and associated data exhibiting the same pattern of context at the second specified time period further comprises searching for the same pattern of context exhibited at a second specified frequency, different than the first specified frequency.

4. The method of claim 3, wherein the second specified frequency is continuous.

5. The method of claim 3, wherein the second specified frequency is discontinuous.

6. The method of claim 1, wherein the first specified frequency is continuous.

7. The method of claim 1, wherein the first specified frequency is discontinuous.

8. The method of claim 1, wherein prior to the step of the computer searching a data structure of synthetic context-based objects and associated data for a pattern of context exhibited at a first specified frequency within a first specified time period, the computer receives at least the first specified frequency and the first specified time period.

9. A computer program product for generating and maintaining synthetic context events, the computer program product comprising:
one or more computer-readable, tangible storage devices;
program instructions, stored on at least one of the one or more storage devices, to search a data structure of synthetic context-based objects and associated data for a pattern of context exhibited at a first specified frequency within a first specified time period;
program instructions, stored on at least one of the one or more storage devices, to combine the synthetic context-based objects and associated data exhibiting the pattern of context exhibited at the first specified frequency within the first specified time period into a synthetic context event; and
program instructions, stored on at least one of the one or more storage devices, to optimize and maintain the synthetic context event by searching the data structure for additional synthetic context-based objects and associated data exhibiting a same pattern of context at a second specified time period different than the first specified time period and adding the additional synthetic context-based objects and associated data to the synthetic context event.

10. The computer program product of claim 9, wherein the program instructions, stored on at least one of the one or more storage devices, to optimize and maintain the synthetic context event by searching the data structure for additional synthetic context-based objects and associated data exhibiting the same pattern of context at the second specified time period further comprises searching for the same pattern of context exhibited at the first specified frequency.

11. The computer program product of claim 9, wherein the program instructions, stored on at least one of the one or more storage devices, to optimize and maintain the synthetic context event by searching the data structure for additional synthetic context-based objects and associated data exhibiting the same pattern of context at the second specified time period further comprises searching for the same pattern of context exhibited at a second specified frequency, different than the first specified frequency.

12. The computer program product of claim 9, wherein the first specified frequency is continuous.

13. The computer program product of claim 9, wherein the first specified frequency is discontinuous.

14. The computer program product of claim 9, wherein prior to the program instructions, stored on at least one of the one or more storage devices, to search a data structure of synthetic context-based objects and associated data for a pattern of context exhibited at a first specified frequency within a first specified time period, receiving at least the first specified frequency and the first specified time period.

15. A system for generating and maintaining synthetic context events, the system comprising:
one or more processors, one or more computer-readable memories and one or more computer-readable, tangible storage devices;
program instructions, stored on at least one of the one or more storage devices for execution by at least one of the one or more processors via at least one of the one or more memories, to search a data structure of synthetic context-based objects and associated data for a pattern of context exhibited at a first specified frequency within a first specified time period;
program instructions, stored on at least one of the one or more storage devices for execution by at least one of the one or more processors via at least one of the one or more memories, to combine the synthetic context-based objects and associated data exhibiting the pattern of context exhibited at the first specified frequency within the first specified time period into a synthetic context event; and
program instructions, stored on at least one of the one or more storage devices for execution by at least one of the one or more processors via at least one of the one or more memories, to optimize and maintain the synthetic context event by searching the data structure for additional synthetic context-based objects and associated data exhibiting a same pattern of context at a second specified time period different than the first specified time period and adding the additional synthetic context-based objects and associated data to the synthetic context event.

16. The system of claim 15, wherein the program instructions, stored on at least one of the one or more storage devices for execution by at least one of the one or more processors via at least one of the one or more memories, to optimize and maintain the synthetic context event by searching the data structure for additional synthetic context-based objects and associated data exhibiting the same pattern of context at the second specified time period further comprises searching for the same pattern of context exhibited at the first specified frequency.

17. The system of claim 15, wherein the program instructions, stored on at least one of the one or more storage devices for execution by at least one of the one or more processors via at least one of the one or more memories, to optimize and maintain the synthetic context event by searching the data structure for additional synthetic context-based objects and associated data exhibiting the same pattern of context at the second specified time period further comprises searching for the same pattern of context exhibited at a second specified frequency, different than the first specified frequency.

18. The system of claim 15, wherein the first specified frequency is continuous.

19. The system of claim 15, wherein the first specified frequency is discontinuous.

20. The system of claim 15, wherein prior to the program instructions, stored on at least one of the one or more storage devices for execution by at least one of the one or more processors via at least one of the one or more memories, to search a data structure of synthetic context-based objects and associated data for a pattern of context exhibited at a first specified frequency within a first specified time period, receiving at least the first specified frequency and the first specified time period.
